(19) United States
(12) Patent Application Publication
(10) Pub. No.: US 2009/0196748 A1
(43) Pub. Date: Aug. 6, 2009

(54) WIND TURBINE IMPROVEMENTS

(75) Inventor: Edmund Salter, Oceanside, CA (US)

Correspondence Address: QUICKPATENTS, INC., 32861 CALLE PERFECTO, SUITE A, SAN JUAN CAPISTRANO, CA, 92675, US

(73) Assignee: GREENWARD TECHNOLOGIES, INC., Austin, TX (US)

(21) Appl. No.: 12/364,903

(22) Filed: Feb. 3, 2009

Related U.S. Application Data
(60) Provisional application No. 61/063,711, filed on Feb. 5, 2008.

(51) Int. Cl. F03D 1/02; F03D 11/04

(52) U.S. Cl. 416/120; 416/162

(57) ABSTRACT

A wind turbine arrangement is disclosed that includes a substantially vertical tower mounted to a ground surface, a horizontally-extending hub rotatably fixed in a substantially horizontal plane to an upper end of the tower, at least one radial support arm rotatably fixed with a distal end of the hub, each support arm including a turbine mounting means at a distal end thereof, and at least one electricity-generating turbine selectively mountable with the turbine mounting means of the any of the support arms. An elevator means adapted to raise and lower each of the turbines between an upper loading position adjacent to a lower loading position of each support arm, and a lower loading position adjacent to the ground surface. In use, each support arm may be rotated to the loading position for receiving one of the turbines thereon. The support arm is then rotated about the hub into an operating position.

### CROSS-REFERENCE TO RELATED APPLICATIONS

This application claims the benefit of U.S. Provisional Patent Application 61/063,711, filed on Feb. 5, 2008, and incorporated herein by reference.

### STATEMENT REGARDING FEDERALLY SPONSORED RESEARCH AND DEVELOPMENT

Not Applicable.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### FIELD OF THE INVENTION

This invention relates to wind turbines, and more particularly to an improved wind turbine configuration.

### DISCUSSION OF RELATED ART

Development of wind energy conversion equipment grew rapidly in the U.S. in the early 1980's when various investment tax incentives were established at the state and federal levels. Technologically, the main distinction has been between vertical axis wind turbines (VAWTs) and horizontal axis machines (HAWTs). The different HAWT approaches are mainly subdivided into downwind (rotor downwind of the tower) vs. upwind (rotor upwind of the tower) rotors, and rotors with two blades vs. three blades. A primary goal of such prior art systems is the production of energy from the wind at the lowest possible cost in terms of the installed cost and the long term overhaul and maintenance costs of the equipment.

Domestic HAWTs of the early 1980's are mainly downwind rotors with two or three blades. Many such installations were new, untested designs that were rushed into production in response to market forces, and many such units were installed before drawbacks with such designs were well understood. In several cases such drawbacks resulted in large-scale catastrophic failure. This led to many expensive retrofit programs, which resulted in a loss of confidence of wind energy project developers in domestically manufactured machines for some time.

As a result, the developers turned to European manufacturers who had been developing upwind three blade machines. Such early European wind turbines were manufactured mainly in Denmark. They rotated more slowly than US-based designs, and were considerably quieter and more graceful in appearance. From about 1983 such Danish designs became the preferred machines for wind energy developers, and US machines were not able to make any significant impact in markets outside the U.S. As a result, by the start of the 1990's, the European wind turbines achieved dominance both in the U.S. and abroad.

The European wind turbines are certainly not immune to design drawbacks. While such designs have relatively low incidence of catastrophic failures, their operating and maintenance (O&M) costs are relatively high, yet fairly predictable. The rotor diameter of these machines has grown from typically 16 meters in 1983 to over 100 meters in 2008. This increase in rotor size has led to myriad problems, among those being:
1. Problems with scaling rotor blades and other major components—Research by James Tangler of the National Renewable Energy Laboratory and others has shown that, for a given design, the mass of the rotor blades varies as the 2.4 power of the diameter, while the energy production varies as the square of the diameter. As a wind turbine rotor rotates, each rotor blade experiences a reversed bending load component due to gravity. On the largest turbines these bending moments are very large—on the order of 0.5 to 1 million ft-lbs. The transmitted shaft torque varies as the cube of the diameter. This is due to the fact that the rotational speed (RPM) of the turbine rotor varies inversely with diameter. Doubling the diameter of a turbine rotor reduces the RPM by half, while increasing the shaft torque by a factor of eight. A 100 meter wind turbine will produce approx. 1.7 million ft-lbs of torque at 15 rpm. Many sites with good wind resources exhibit “wind shear,” which is a velocity gradient as a function of height. However, some sites exhibit severe wind shear at certain times of year and in specific weather conditions. With very large rotors, the wind shear produces much higher thrust forces on a blade that is at the top of the rotor versus the same blade as it passes through the lowest point in its travel. This produces extreme bending loads on the main shaft, as well as on the blade “roots,” or attachment means to a rotor, and other critical load bearing components. Such forces can lead to fatigue-related failures.
2. Problems with availability of new equipment and replacement parts—Supply chain, shipping problems and other issues associated with size have limited the growth of the industry and as a result the largest machines can only be obtained by the largest developers with long term purchase agreements with manufacturers.
3. Effect on the wind resource—Large turbine rotors leave behind wakes containing powerful and long-lasting turbulence. This requires larger separation distances—on the order of 8 rotor diameters—between wind turbines in an array, thereby limiting the capacity of the wind resource land to approx. 60 acres per megawatt of capacity.

In my previous patent, U.S. Pat. No. 4,110,631 issued on Aug. 29, 1978, I taught a means of utilizing three or more relatively small rotors on a single tower. While utilizing a larger number of smaller turbines overcomes many of the drawbacks of the larger rotor sizes common today, my prior device is not easily scalable to present-day rotor sizes and installations, and still includes many of the same drawbacks heretofore mentioned.

Therefore, there is a need for a device that provides for the use of multiple mid-size, lightweight, modular wind turbines in counter-rotating arrays that can be oriented to face a changing wind direction. Such a needed device would provide for a relatively low cost of energy generated, and provide reduced downtime—and consequent lost revenue due to major mechanical or electrical failures—by allowing rapid replacement of wind turbine modules. Further, the needed device would provide means to raise and lower turbine modules, thereby eliminating the need for large cranes when performing maintenance. Such a needed device would increase the total amount of energy generated per acre of wind resource, and improve supply chain economics due to the smaller size of the individual components and increased component order quantities. The present invention accomplishes these objectives.

### SUMMARY OF THE INVENTION

The present device is a wind turbine arrangement that includes a substantially vertical tower mounted to a ground surface. A horizontally-extending hub is rotatably fixed in a substantially horizontal plane to an upper end of the tower. At least one radial support arm is rotatably fixed with a distal end of the hub, each support arm including a turbine mounting means at a distal end thereof. At least one, but preferably four, electricity-generating turbines are each selectively mountable with the turbine mounting means of any of the support arms.

The tower includes an elevator means adapted to raise and lower one of the turbines between an upper loading position adjacent to a lower loading position of each support arm, and a lower loading position adjacent to the ground surface. In use, each support arm may be rotated to its loading position for receiving one of the turbines thereon. The support arm is then rotated about the hub into an operating position. In the preferred embodiment, the hub is positioned about the tower such that each turbine is upwind of the tower. As such, each turbine is able to operate with minimal turbulent effect from the tower and aerodynamically-shaped support arms.

In an exemplary embodiment, the tower includes four 50 m diameter turbines, for a combined power rating of 2.4 MW, which is comparable to a prior art single turbine device with a blade diameter of 100 meters with a similar 2.4 MW power rating. Such a prior art turbine, however, is difficult to source, install, and maintain.

The present device provides for the use of multiple mid-size, lightweight, modular wind turbines in counter-rotating arrays that can be oriented to face a changing wind direction. The present invention results in a relatively low cost for generated energy, and provides for reduced downtime—and consequent lost revenue due to major mechanical or electrical failures—by allowing rapid replacement of wind turbine modules. The present arrangement provides means to raise and lower turbine modules, thereby eliminating the need for large cranes when performing maintenance. The instant invention increases the total amount of energy generated per acre of wind resource, and improves supply chain economics due to the smaller size of the individual components and increased component order quantities. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention;

FIG. 2 is a side elevational view of the invention, illustrating an elevator means thereof in an upper loading position and a support arm thereof in a loading position;

FIG. 3 is a partial cut-away view of a hub of the invention;

FIG. 4 is a partial perspective view of an elevator means of the invention;

FIG. 5 is a partially cut-away view of a fork arrangement and a wind turbine;

FIG. 6 is an enlarged partial perspective view of a trunnion receiver of the invention;

FIG. 7 is a partial cross-sectional view of the invention, taken generally along lines 7-7 of FIG. 5;

FIG. 8 is an enlarged left-side elevational view thereof, illustrating a turbine as fixed with the support arm;

FIG. 9 is an enlarged left-side elevational view thereof, illustrating the turbine as disconnected with the support arm and supported by the elevator means;

FIG. 10 is a partial perspective view thereof, illustrating the turbine as being lowered to a ground surface by the elevator means;

FIG. 11 is a perspective view of an alternate embodiment of the invention; and

FIG. 12 is a perspective view of another alternate embodiment of the invention.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

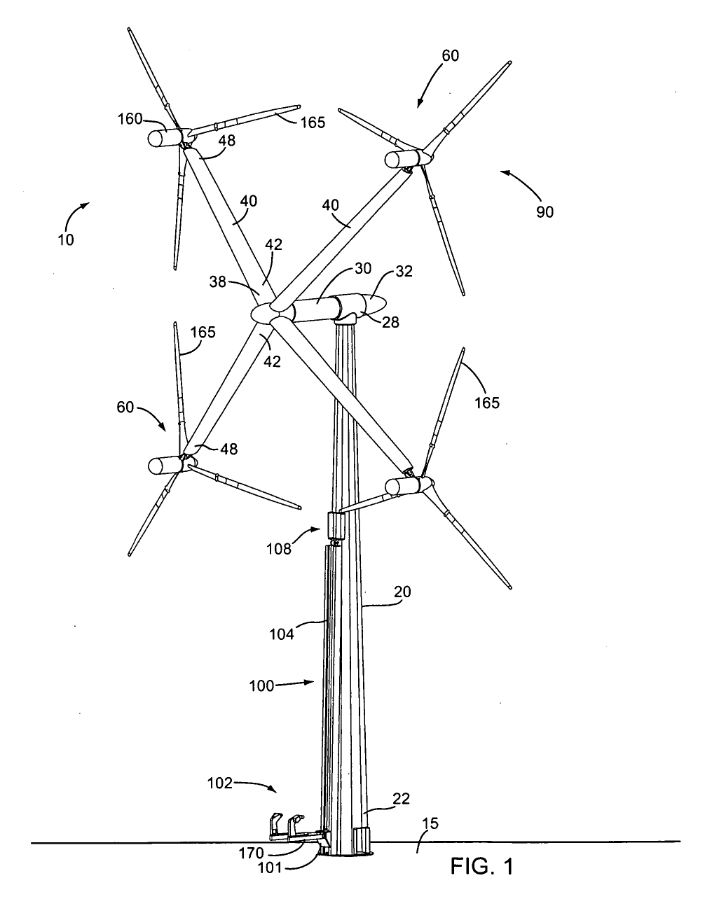

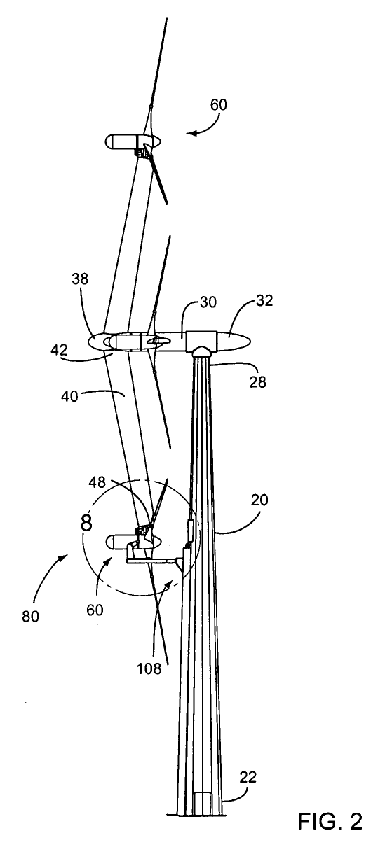

FIGS. 1 and 2 illustrate a wind turbine arrangement 10 installed on a ground surface 15, preferably in a significantly windy outdoor environment. The ground surface 15 may be on dry land, or under shallow water, for example. A tower 20 of the arrangement 10 has an upper end 28 and a lower end 22. The tower 20 is adapted to be fixed on the ground surface 15 in a substantially vertical orientation, and is made from a substantially rigid metal, concrete, or other suitably strong material capable of withstanding substantial wind and weight forces. The tower 20 may be at least partially hollow to allow internal vertical access to the upper end 28 therein through an access door and an internal ladder, as is known in the art. Preferably the tower 20 is 250% as high as an individual turbine 60 diameter; for example, 50 m turbine 60 diameters would preferably be installed on a 125 m tall tower 20 of the present arrangement 10.

A hub 30 is rotatably fixed proximate the upper end 28 of the tower at a proximal end 32 thereof and projects substantially horizontally therefrom. The hub includes a distal end 38. Preferably the hub 30 may be rotated through several full rotations about the tower 20 on suitable bearings 29. The hub 30 is substantially hollow to allow access to the distal end 38 therein and is made from a suitably strong and rigid metal material.

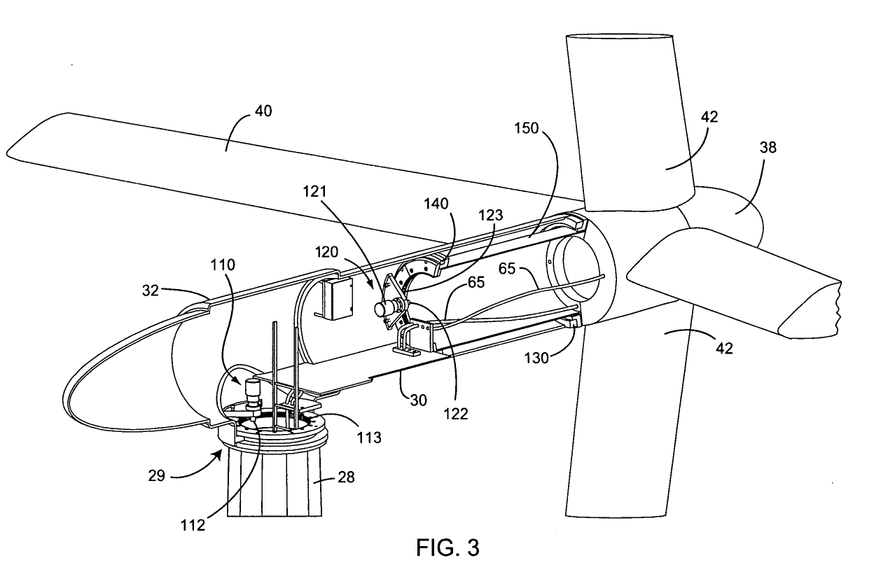

At least one radial support arm 40 is included, each rotatably fixed at a proximate end 42 thereof with the distal end 38 of the hub 30. Each support arm 40 includes a turbine mounting means 50 at a distal end 48 thereof. The distal end 38 of the hub 30 preferably includes a second motorized rotating means 120, such as an electric motor 121 having a pinion gear 122 that rides along an annular gear 123 of a bearing tube 150, for rotating the support arms 40 about the hub 30 (FIG. 3). Each support arm 40 may be rotated through an angle of less than 150-degrees, for example, such that electrical cables 65 do not twist together inside the hub 30.

At least one electricity-generating turbine 60 is included, each having a support arm mounting means 70 cooperative with the turbine mounting means 50 of each support arm 40. As such, selective mounting of each turbine 60 on any one of the support arms 40 may be accomplished, the support arm mounting means 70 and the turbine mounting means 50 cooperative to effect a strong mechanical and sure electrical connection between the turbine 60 and one of the electric cables 65 internal to the support arm 40. Each support arm 40 is made from a substantially rigid and strong material capable of supporting one of the turbines 60. Further, each support arm 40 has a drag-reducing aerodynamic shape in cross-section, so as to reduce wind turbulence upwind of the turbine 60.

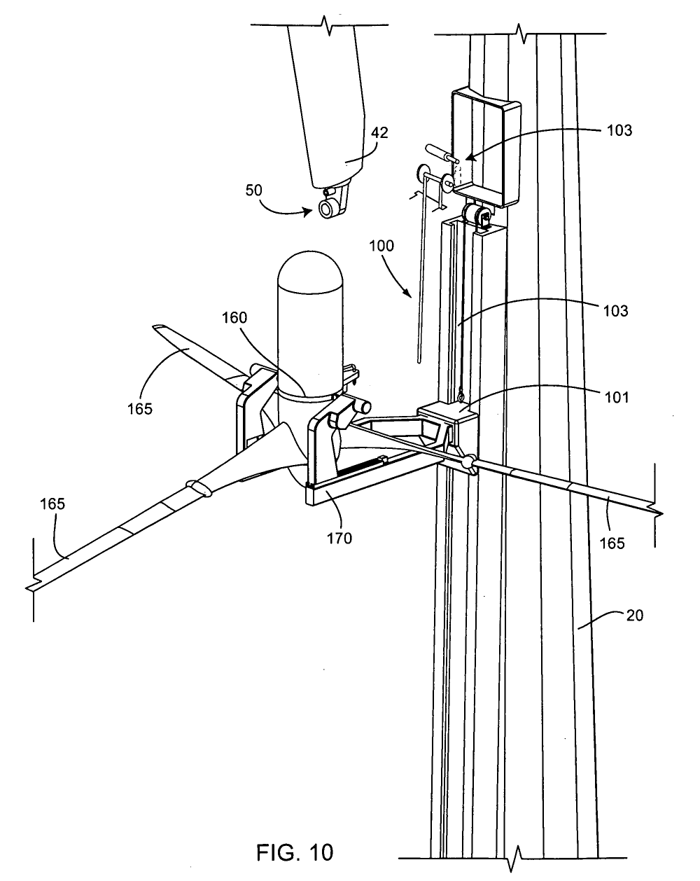

Preferably the tower 20 includes an elevator means 100 adapted to raise and lower one of the turbines 60 between an upper loading position 108 adjacent to the loading position 80 of each support arm 40, and a lower loading position 102 adjacent to the ground surface 15. Such an elevator means 100 may include, for example, an elevator trolley 101 captured vertically by an elevator rail 104 of the tower 20 and selectively movable between the upper loading position 108 and the lower loading position 102 by a winch system 103, such as an electric motor and cable pulley arrangement (FIG. 10). The elevator trolley 101 may be selectively removed from the tower 20 (FIG. 2) when desired, such as when arrangement 10 is in a standard operating mode, for example. Clearly such a lower loading position 102 is situated above a high-tide expected height in installations where the ground surface 15 is under water. In such an installation, a dock (not shown) may be further fixed to the tower 20.

Preferably the arrangement 10 has an even number of support arms 40 and turbines 60, such that each support arm 40 and turbine 60 includes an opposing support arm 40 and turbine 60 opposite the hub 30. Preferably each turbine 60 rotates in a direction opposite of that of its adjacent turbine 60. Such counter-rotating opposing turbines 60 effectively cancel torque forces on the hub 30. In one embodiment of the invention, the arrangement 10 includes four turbines 60 (FIG. 1) on four support arms 40.

The hub 30 may further include an upwind bearing 130 and a downwind bearing 140 for rotatably mounting of each support arm 40. The bearing tube 150 is fixed between each bearing 130,140 and adapted to receive the power cables 65 from each turbine 60 through each support arm 40, such that during support arm 40 rotation each cable 65 is kept substantially away from the other cables 65, such cables 65 being prevented from twisting or abrading each other.

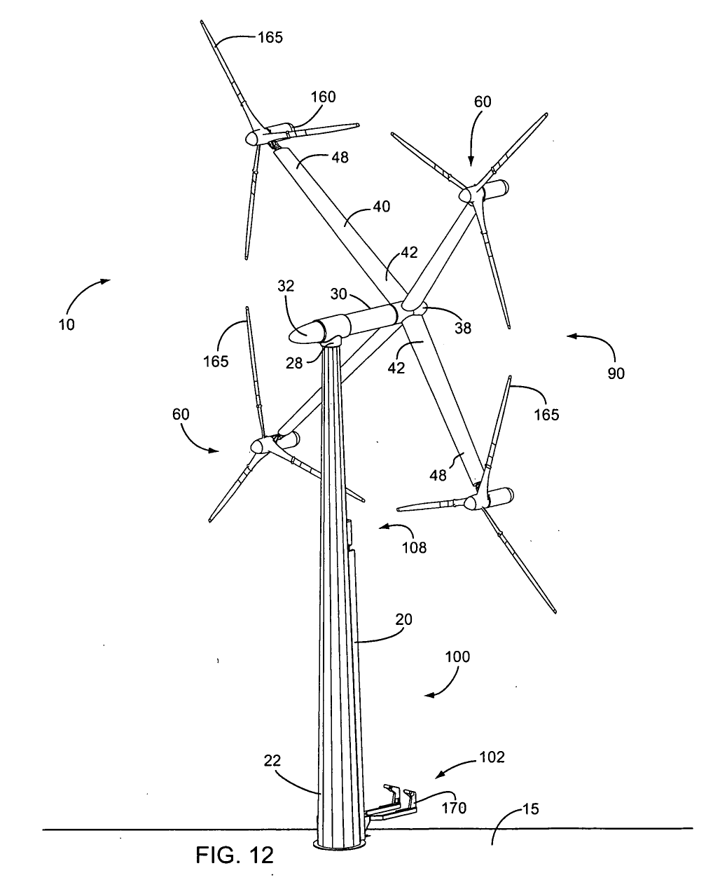

In use, each support arm 40 may be rotated to a loading position 80 for receiving one of the turbines 60 thereon, and the hub 30 is rotated about the tower 20 to properly align the turbine 60 with the elevator means 100 of the tower. The support arms 40 may be locked into position with a plurality of suitable bolts (not shown) or other suitable locking means, and the hub 30 may be locked into position also with a plurality of suitable bolts (not shown) or other suitable locking means. The turbine 60 is then loaded onto the support arm with the elevator means 100, which is described in more detail below. The support arm 40 is then rotated about the hub 30 into an operating position 90. In one embodiment, the hub 30 is then rotated about the tower 20 such that each turbine 60 is upwind of the tower 20. As such, each turbine 60 is able to generate electrical power with minimal turbulent effect from the tower 20. In an alternate embodiment of the invention, illustrated in FIG. 12, each turbine 60 is upwind of each support arm 40 and downwind of the tower 20.

The upper end 28 of the tower 28 may further include a motorized rotating means 110, such as an electric motor 111 with a pinion gear 112 that rotates an annular gear 113, for rotating the hub 30 about the tower 20 (FIG. 3), preferably through one full rotation of about 360 degrees.

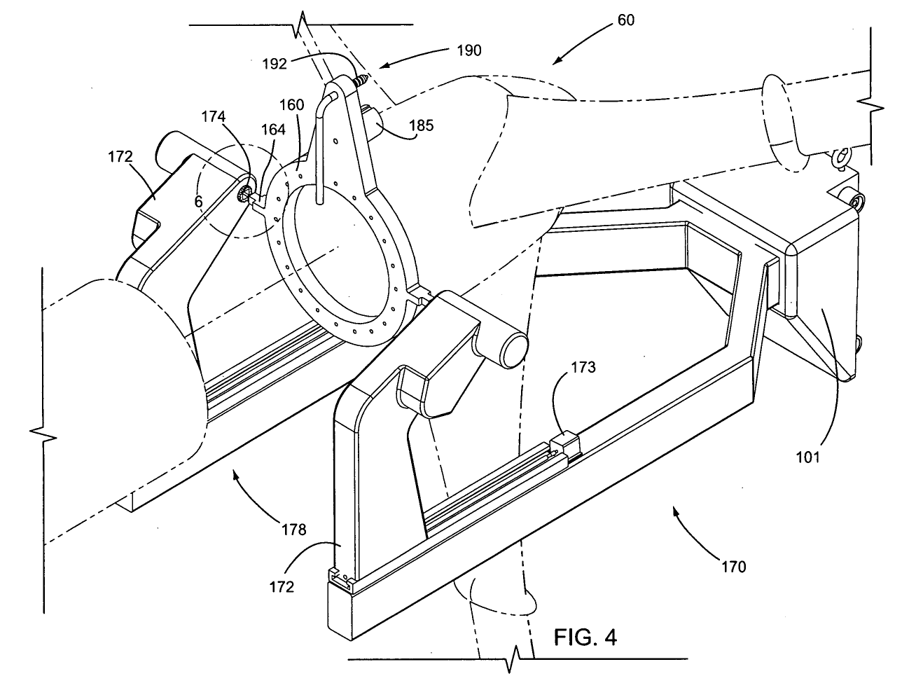

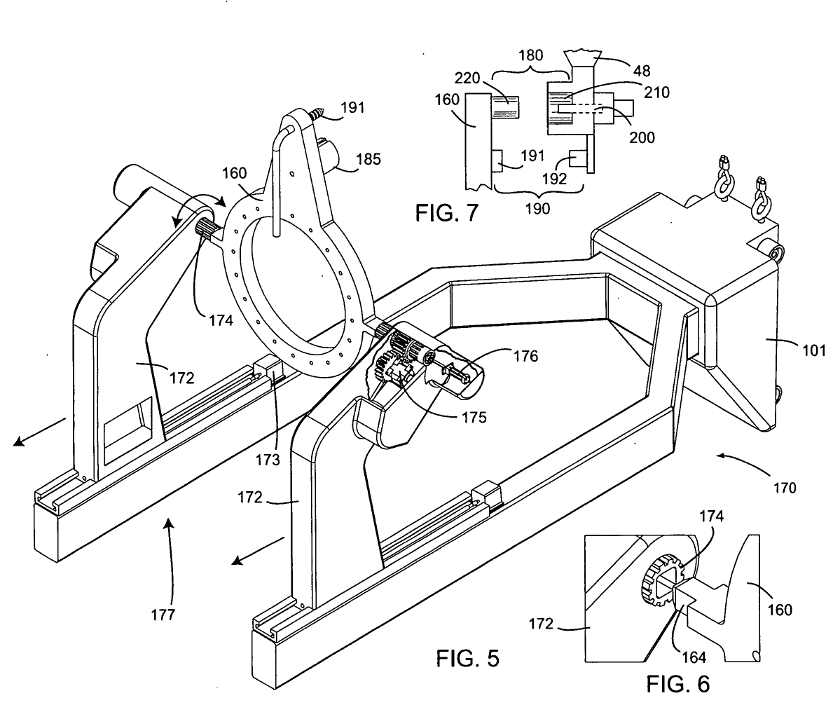

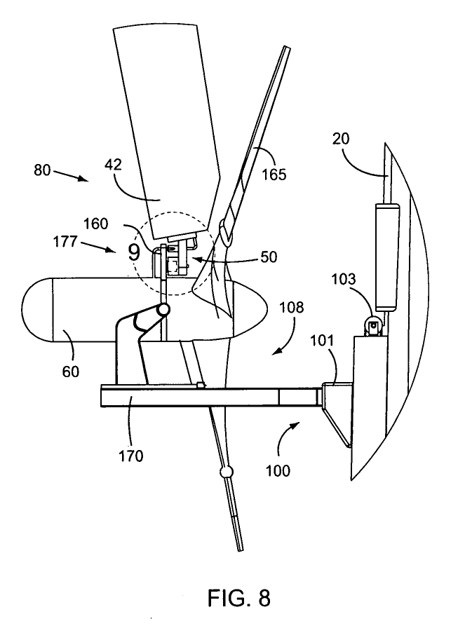

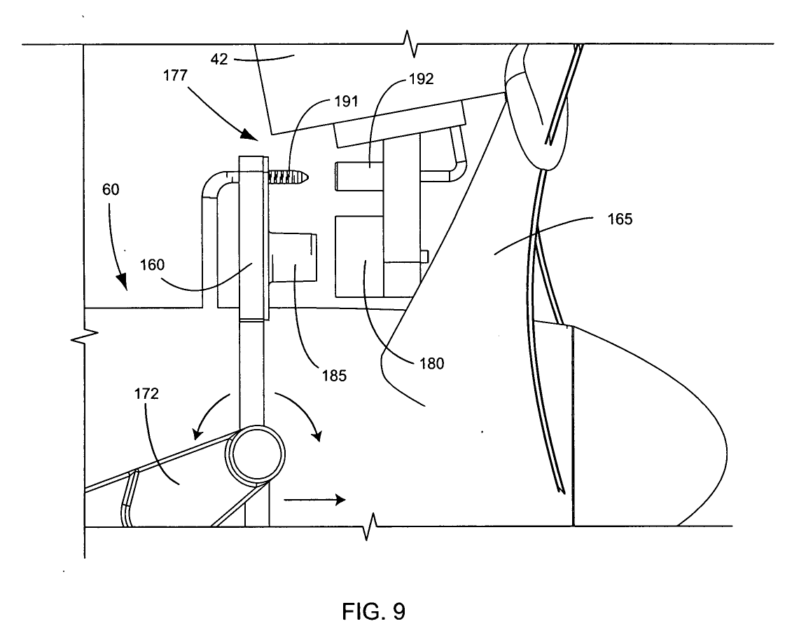

Preferably each turbine 60 includes at least a chassis 160 and a set of rotating blades 165 rotatably fixed thereto. The chassis 160 further includes a pair of opposing non-circular trunnions 164. Further, the elevator means 100 includes a fork arrangement 170 fixed to the elevator trolley 101 that is adapted to receive the opposing trunnions 164 with a pair of trunnion receivers 174. Each trunnion receiver 174 may be rotated with an electric motor and transmission arrangement 175, and extended with a trunnion receiver extension means 176, such as a hydraulic cylinder arrangement (FIG. 5). Each trunnion receiver 174, motor and transmission arrangement 175, and extension means 176 is fixed with a trunnion fork 172 that is selectively positionable with a motorized threaded shaft 173 between a turbine-engaged position 177 (FIGS. 5 and 8) and a turbine-disengaged position 178 (FIGS. 4 and 9). As such, each trunnion receiver 174 is selectively rotatable to effect pitch alignment and each trunnion fork 172 is positionable to effect engagement/disengagement of the turbine 60 with one of the support arms 40 at the upper loading position 108 (FIGS. 4-9).

The turbine mounting means 50 of each support arm 40 preferably includes a keyed post receiver 180, and the chassis 160 of each turbine 60 further includes a keyed mounting post 185 adapted to be selectively engaged with the keyed post receiver 180 of each support arm 40. In such an embodiment, the turbine mounting means 50 of each support arm 40 further includes one part 191 of a two-part electrical connector 190, and the chassis 160 of each turbine 60 includes a second part 192 of the two-part electrical connector 190, such that each turbine 60 may be selectively mechanically and electrically fixed to one of the support arms 40 thereby. A bolt 200, or the like, mechanically locks the keyed mounting post 185 to the keyed post receiver 180.

Alternately, the turbine mounting means 50 of each support arm 40 includes a keyless post receiver 210 (FIG. 7) and the chassis 160 of each turbine 60 further includes a keyless mounting post 220 adapted to be selectively engaged with the keyless post receiver 210 of each support arm 40. The bolt 200, or the like, mechanically locks the keyless mounting post 220 to the keyless post receiver 210.

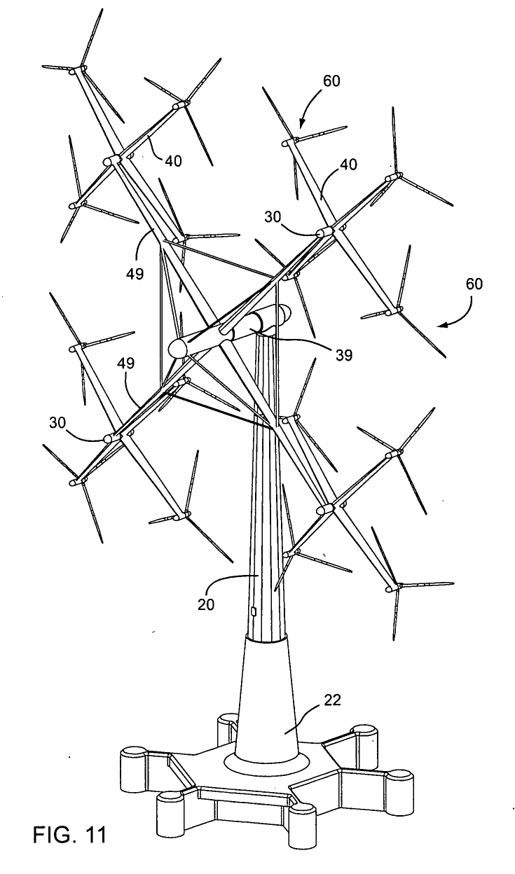

While a particular form of the invention has been illustrated and described, it will be apparent that various modifications can be made without departing from the spirit and scope of the invention. For example, various configurations of support arms 40 and turbines 60 may be included, such as the embodiment illustrated in FIG. 11 in which selectively rotatable sets of four turbines 60 and four support arms 40 are each fixed to a selectively rotatable hub 30 that is itself fixed to distal ends of four master support arms 49, the arrangement 10 in such an embodiment resulting in sixteen turbines 60 and sixteen support arms 40, one four hubs 30, and a master hub 39. Preferably, in any embodiment, the blades 165 of each turbine 60 rotate in a substantially common plane, and each support arm 40 is fashioned in a length such that blades 165 of adjacent turbines 60 cannot contact each other. Accordingly, it is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in its implementation details, while still being encompassed by the invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A wind turbine arrangement for installation on a ground surface, comprising:
a tower having an upper end and a lower end, the tower adapted to be fixed on the ground surface in a substantially vertical orientation;
a hub rotatably fixed proximate the upper end of the tower at a proximal end thereof and projecting substantially horizontally therefrom, the hub including a distal end;
at least one radial support arm, each rotatably fixed at a proximate end thereof with the distal end of the hub and including a turbine mounting means at a distal end thereof, and
at least one electricity-generating turbine, each having a support arm mounting means cooperative with the turbine mounting means of each support arm to allow selective mounting of each turbine on any one of the support arms.

2. The wind turbine arrangement of claim 1 wherein the tower further includes an elevator means adapted to raise and lower one of the turbines between an upper loading position adjacent to the loading position of each support arm and a lower loading position adjacent to the ground surface.

3. The wind turbine arrangement of claim 1 having an even number of support arms and turbines, such that each support arm and turbine includes an opposing support arm and turbine opposite the hub.

4. The wind turbine arrangement of claim 3 wherein each turbine rotates in a direction opposite of that of its opposing turbine.

5. The wind turbine arrangement of claim 1 wherein the upper end of the tower further includes a motorized rotating means for rotating the hub about the tower.

6. The wind turbine arrangement of claim 1 wherein the distal end of the hub further includes a second motorized rotating means for rotating the support arms and turbines about the hub.

7. The wind turbine arrangement of claim 6 wherein each support arm may be rotated through an angle of less than 150-degrees.

8. The wind turbine arrangement of claim 1 wherein the distal end of the hub further includes an upwind bearing and a downwind bearing for rotatably mounting of each support arm, a bearing tube being fixed therebetween and adapted to receive power cables from each turbine through each support arm such that during support arm rotation each cable is kept distally apart from the other cables.

9. The wind turbine arrangement of claim 1 wherein the hub may be rotated through at least one full rotation.

10. The wind turbine arrangement of claim 2 wherein each turbine includes at least a chassis and a set of rotating blades rotatably fixed thereto, the chassis further including a pair of opposing non-circular trunnions, and wherein the elevator means includes a fork arrangement adapted to receive the opposing trunnions with a pair of trunnion receivers, each trunnion receiver selectively rotatable to effect pitch alignment of the turbine with one of the support arms at the upper loading position.

11. The wind turbine arrangement of claim 10 wherein the turbine mounting means of each support arm includes a keyed post receiver and wherein the chassis of each turbine further includes a keyed mounting post adapted to be selectively engaged with the keyed post receiver of each support arm, the turbine mounting means of each support arm further including one part of a two-part electrical connector, the chassis of each turbine including a second part of the two-part electrical connector, such that each turbine may be selectively mechanically and electrically fixed to one of the support arms thereby.

12. The wind turbine arrangement of claim 11 wherein a bolt mechanically locks the keyed mounting post to the keyed post receiver.

13. The wind turbine arrangement of claim 10 wherein the turbine mounting means of each support arm includes a keyless post receiver and wherein the chassis of each turbine further includes a keyless mounting post adapted to be selectively engaged with the keyless post receiver of each support arm, the turbine mounting means of each support arm further including one part of a two-part electrical connector, the chassis of each turbine including a second part of the two-part electrical connector, such that each turbine may be selectively mechanically and electrically fixed to one of the support arms thereby.

14. The wind turbine arrangement of claim 12 wherein a bolt mechanically locks the keyed locking post to the keyed post receiver.

15. The wind turbine arrangement of claim 1 wherein a plurality of hubs are included, each fixed to a master support arm, each master support arm itself rotatably fixed to a selectively rotatable master hub.
